(19) United States
(12) Patent Application Publication
(10) Pub. No.: US 2010/0161399 A1
(43) Pub. Date: Jun. 24, 2010

(54) INSTANT PAYOUT INCENTIVE SYSTEM

(76) Inventors: Nicholas David Posner, San Carlos, CA (US); Jed Thomas Clevenger, San Francisco, CA (US); Michael We Chun Wu, Mountain View, CA (US); Matthew P. Deunison, Oakland, CA (US); Srinivasan Raman, Cupertino, CA (US)

Correspondence Address: SCHWEGMAN, LUNDBERG & WOESSNER/EBAY, P.O. BOX 2938, MINNEAPOLIS, MN, 55402, US

(21) Appl. No.: 12/619,483

(22) Filed: Nov. 16, 2009

Related U.S. Application Data
(60) Provisional application No. 61/114,765, filed on Nov. 14, 2008.

(51) Int. Cl. G06Q 30/00; G06Q 10/00

(52) U.S. Cl. 705/14.13; 705/14.34

(57) ABSTRACT

Methods, apparatus, and systems to process transactions in a networked communication system, including cash back rebate eligible transactions. Some embodiments provide for distributed risk analysis of transactions, such as to provide for a probability analysis of transaction completion at a payment server. The payment server then makes a recommendation for reward timing or payout of a cash back reward.

### CROSS-REFERENCE TO RELATED APPLICATIONS

The present application claims priority to, and the benefit of, U.S. Provisional Patent Application No. 61/145,765 filed Nov. 14, 2008 and entitled “Instant Payout Incentive System” and is hereby incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2009 eBay Inc. All Rights Reserved.

### BACKGROUND

Electronic communications provide convenient mechanisms to transact business. Such connectivity of systems allows sellers to offers rebates, awards and promotions quickly and facilitates confirmation of transaction information.

### BRIEF DESCRIPTION OF THE DRAWINGS

FIGS. 1 and 2 are block diagrams illustrating a system having a client-server architecture to provide transactional services supporting rebates, awards and promotions, according to an example embodiment;

FIG. 3 illustrates a flow diagram of a method to provide rebates in a in a transactional system, according to an example embodiment;

FIG. 4 is a block diagram illustrating a system and apparatus for implementing an architecture for implementing a rebate system, according to an example embodiment;

FIG. 5 illustrates a flow diagram of one example of messaging within a system;

FIG. 6 illustrates a user interface for a rebate system, according to an example embodiment;

FIG. 7 illustrates another user interface for a rebate system, according to an example embodiment;

FIG. 8 is a flow diagram illustrating check out processing, according to an example embodiment;

FIG. 9 is a flow diagram illustrating operation of a rebate system, according to an example embodiment;

FIG. 10 is a diagram illustrating a payment interface, according to an example embodiment;

FIG. 11 is a diagram illustrating a Confirm Your Purchase (CYP) user interface, according to an example embodiment;

FIG. 12 is a diagram illustrating a user interface for a cash back reward notification to a user, according to an example embodiment;

FIG. 13 is a diagram illustrating a user interface to service a cash back reward, according to an example embodiment;

FIG. 14 is a flow diagram of a method for determining when to apply a rebate, according to an example embodiment;

FIG. 15 is a diagram illustrating a recommendation matrix for rebate timing, according to an example embodiment;

FIG. 16 is a flow diagram illustrating a check out flow in a system supporting rebates, according to an example embodiment;

FIG. 17 is a table summary of various rebate scenarios, according to example embodiments;

FIG. 18 is a flow chart illustrating a process for handling transactions eligible for rebates, according to an example embodiment;

FIG. 19 is a flow chart illustrating a process for handling transactions eligible for rebates, according to an example embodiment;

FIG. 20 is a flow chart illustrating a process for handling transactions eligible for rebates, according to an example embodiment;

FIG. 21 illustrates a system for applying rebates to transactions according to an example embodiment;

FIG. 22 illustrates a system for applying rebates to transactions according to an example embodiment; and

FIG. 23 illustrates a computing system for processing transactions and applying a risk analysis to rebate processing, according to an example embodiment.

### DETAILED DESCRIPTION

In the following description, for purposes of explanation, numerous specific details are set forth in order to provide a thorough understanding of some example embodiments. To one skilled in the art, it is evident that the concepts presented herein may be practiced without these specific details.

Methods and systems to enhance search capabilities in a network accessible information resource including analyzing transactions to determine a risk of applying a rebate are described.

According to an example embodiment, there is provided a system providing rebate processing which performs risk processing to evaluate whether a transaction will complete without return. Risk processing considers whether a consumer will purchase a product or complete the terms of a transaction or service agreement without returning or exchanging the product and without cancelling the service. Such termination and non-completion of a transaction may be problematic when a rebate or other incentive award has been provided to the consumer, requiring the merchant or service provider to retrieve the reward or “claw back” the monies. Therefore, risk processing considers parameters of the transactions which may be related to the seller, buyer, product, venue, time of sale and other considerations. The risk analysis may be distributed to various entities in the system so as to reduce the risk to any one entity and thereby share the risk among entities. In some embodiments, a payment server performs the risk analysis using statistics and historical information available to the payment server as handling financial transactions for a broad range of transactions.

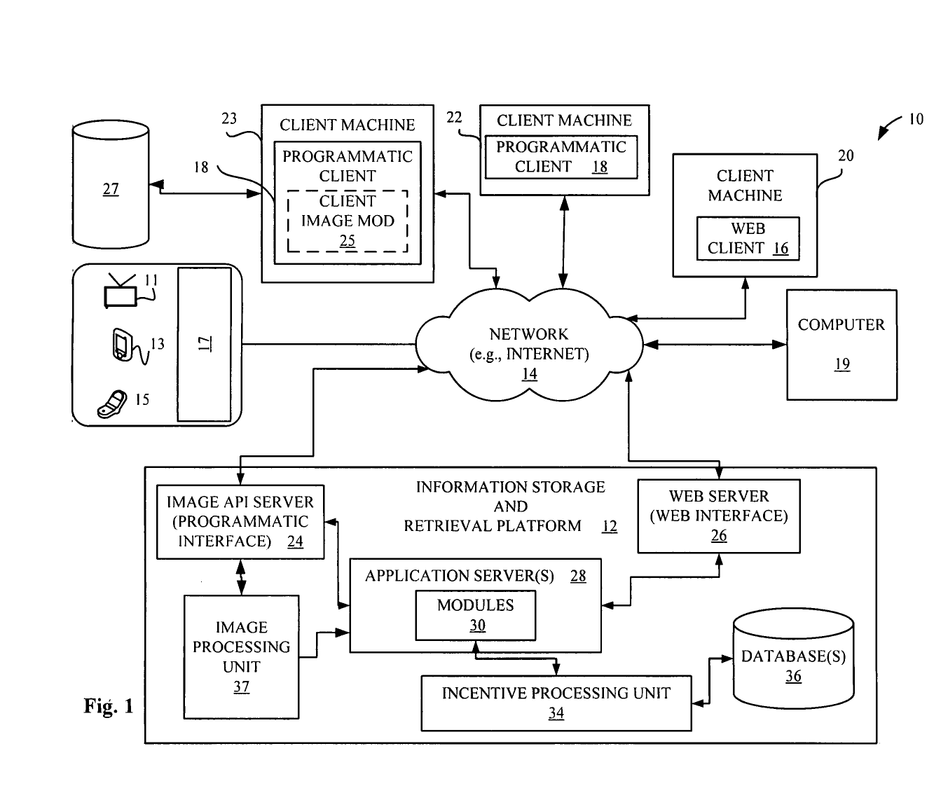

One example embodiment of a distributed network is illustrated in the network diagram of FIG. 1 which depicts a system 10 using a client-server type architecture. A commerce platform or commerce server includes an information storage and retrieval platform 12, which provides server-side functionality, via a network 14 (e.g., the Internet) to one or more clients. As illustrated, a system 10 interacts with a web client 16 executing on a client machine 20, a programmatic client 18 executing on a client machine 22, and a programmatic client 18 in the form of client image modules 25 executing on a client machine 23. In one embodiment, web client 16 is a web browser, but may employ other types of web services.

Within the information the storage and retrieval platform 12, Application Program Interface (API) server 24 and web server 26 are coupled to, and provide programmatic and web interface to, one or more application servers 28. Application servers 28 host one or more modules 30 (e.g., modules, applications, engines, etc.). Application servers 28 are also coupled to an incentive processing unit 34 that facilitates access to one or more databases 36. Modules 30 provide a number of information storage and retrieval functions and services to users accessing the information storage and retrieval platform 12. A user accesses information storage and retrieval platform 12 through network 14.

While system 10 of FIG. 1 employs a client-server architecture, the present disclosure is not limited to this architecture, and could be applied to a distributed, or peer-to-peer, architecture system. The various modules 30 and may also be implemented as stand-alone software programs, which do not necessarily have networking capabilities.

The web client 16 may access the various modules 30 via a web interface supported by web server 26. Web server 26 allows developers to build web pages. In one embodiment, web server 26 is used in collaboration with Java® technologies by Sun Microsystems of Menlo Park, Calif., and with Ajax (Asynchronous JavaScript and XML) technologies, which is a collection of technologies enabling the creation of web applications. Ajax uses JavaScript, eXtensible Markup Language (XML), Cascading Style Sheet (CSS) formatting, along with a few other technologies. Ajax allows programmers to refresh certain parts of a web page without having to completely reload the page. By obtaining information dynamically, web pages load faster, respond more quickly to requests, and are more functional. Developers consider using Ajax applications, and Ajax-like applications, when seeking to reduce network latency in certain applications.

Similarly, programmatic client 18 accesses various services and functions provided by the modules 30 via the programmatic interface provided by the API server 24. In one example, programmatic client 18 is a seller application (e.g., the TurboLister® application developed by eBay Inc., of San Jose, Calif.) enabling sellers to author and manage data item listings, with each listing corresponding to a product or products, on information storage and retrieval platform 12. Listings may be authored and modified in an off-line manner such as when a client machine 20, 22, or 23 is not necessarily connected to information storage and retrieval platform 12. Client machines 20, 22 and 23 are further to perform batch-mode communications between programmatic clients 18 and 25 and information storage and retrieval platform 12. In addition, programmatic client 18 and web client 16 may include authoring modules (not shown) to author, generate, analyze, and publish categorization rules used in information storage and retrieval platform 12 to structure data items and transform queries. In one example embodiment, transforming queries uses a data dictionary with token pairs to expand a narrow keyword or to focus a broad keyword. The client machine 23 is further shown to be coupled to one or more databases 27. The databases 27 include information used by client machine 23 in implementing a service or operation and may include specific information for products or services offered by client machine 23.

Users having access to service(s) provided by client machine 23, for example, include users of computer 19 and users of wireless network 17, which may serve as a common access point to network 14 for a variety of wireless devices, including, among others a cable type television service 11, a Personal Digital Assistant (PDA) 13, and a cellular phone 15.

In one example, client machine 23 enables web services, wherein a catalog of web services is stored in information storage and retrieval platform 12. Client machine 23 stores information related to use of the web services in databases 27, wherein the information is used to identify associated services and offerings. The associated services and offerings are also listed in the catalog of web services. Descriptors of the associated services and offerings may be used to generate and modify a vocabulary for a data dictionary corresponding to the catalog of web services, such that a user search having keywords related to a first service may return results for a second service associated with the first service. Additionally, each of client machines 20, 22 and 23 may also be users that search data items in information storage and retrieval platform 12.

In another example, client machine 23 is an ecommerce client offering products to customers via Internet 14. Client machine 23 stores a catalog of products and service in information storage and retrieval platform 12, with the catalog of products having a corresponding data dictionary. Client machine 23 stores information related to at least one product or service in databases 27. The information may include frequency of searches, resultant sales, related products, pricing information, and other information related to customer use of the ecommerce service. Additionally, databases 27 may store other product related information, such as style, color, format, and so forth. Client machine 23 may use the information stored in databases 27 to develop descriptor information for at least one product. Product descriptors and other product information may be used to generate and modify a vocabulary for a data dictionary corresponding to the catalog of products, such that a user search having keywords related to a first product may return results for a second product associated with the first service. In other embodiments, a client machine may store information in information and storage retrieval platform 12 related to business processes, or other applications which store data in a database which may be accessed by multiple users. A common problem in such systems is the ability to understand and anticipate multiple users' keywords entered in search queries as search terms. Each of the multiple users may use different keywords to search for a same data item. The use of a data dictionary corresponding to data items enhances a search mechanism in returning the same data item to different users resulting from searches on different keywords.

To facilitate search within information storage and retrieval platform 12, image processing unit 37 provides image processing services, including image recognition of data received from a client machine and image compression processing. The image processing unit 37 may operate on information received from client machines 20, 22, and 23, such as product or service descriptor information, as well as other information related thereto. Image processing unit 37 processes this information to compare received information to stored data for items, such as barcode information of an item or a photograph or other image found outside of system 10. The image processing unit 37 may further provide data compression to reduce the size of received information to facilitate storage, further processing, and transfer of information to another entity. The image processing unit 37 also aids in searching data items stored in databases 36, by matching the received information to known data. Such comparison and matching may use any of a variety of techniques. Further, the received information is similar to search query information, which is traditionally entered as textual information or by selection of categories presented to a user. The image processing unit 37 allows the system 10 to handle image based queries.

In one embodiment, the received image information corresponds to data item information (e.g., product information). In addition, the received image information may correspond to non-specific items, such as to a category of items, which are identified and then presented to the requester.

Where the quality of a search mechanism (e.g., a search engine) to search an information resource is measured by the ability to return search results of interest to the user (e.g., search requester) in response to a search query, image processing unit 37 dramatically expands the type of information and specificity of information a requester may submit as the subject of a search. For example, a search mechanism may respond to a query from a user with search results that contain data items covering a spectrum wider than the interests of the user. Traditionally, the user may then experiment by adding additional constraints (e.g., keywords, categories, etc.) to the query to narrow the number of data items in the search results; however, such experimentation may be time consuming and frustrate the user. To this end, the use of image information in many cases provides an exact, and often unique, identification of the desired item.

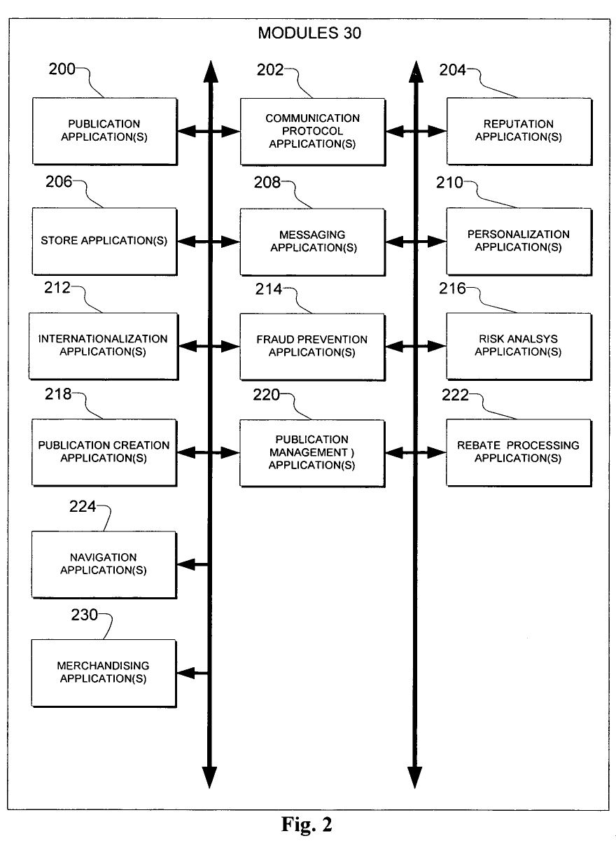

Continuing with system 10 of FIG. 1, information storage and retrieval system 12 includes modules 30 within application server(s) 28, wherein modules 30 is further detailed in FIG. 2. The modules 30 may include software modules or functionality of a module implemented at least partially in software. The software may be developed using a flexible programming language, such as Java. Java® is an object-oriented programming language developed by Sun Microsystems. Other languages and development tools may be used according to the design and purpose and at the discretion of the system developer.

In some instances, modules 30 include a receiver (not shown) to receive images and other information from entities within system 10, such as through network 14. Further included within modules 30 is communication protocol application(s) 202, to receive, process and transmit messages according to one or multiple communication protocols. In one example, communication protocol unit(s) 202 processes GET-POST messages. In this example, a Hypertext Transfer Protocol (HTTP) is used to publish and retrieve text pages on the Internet. HTTP now allows users to generate numerous requests to perform a wide variety of tasks. For instance, it is possible to generate a request to obtain the meta-information of some file located on a remote server. The two fundamental request types of HTTP are GET and POST. The GET request encodes data into a Uniform Resource Locator (URL), while a POST request appears in a message body. The URL identifies a location of a participant in an HTTP communication. Typically GET requests involve retrieving or “getting” data, and a POST request is not so limited, applying to storing data, updating data, sending an email, ordering a product or service.

GET requests embed the parameters of requests in the URL as parameter-value pairs. An example of the resulting URL is provided as:

HTTP://www.site.com/get.cgi?name=John&zip=012345.

POST requests require additional space in the request itself to encode the parameters. The additional space is well used when a large number of parameters or the values are desired or required, but such a large number of parameters are too voluminous to be embedded directly into a URL. For example, a POST request is used when transferring contents of a file from a browser to a server.

The modules 30 further includes publication application(s) 200 to present information describing products and services to users, store application(s) 206, internationalization application(s) 212, publication creation application(s) 218, navigation application(s) 224, and merchandising application(s) 230. These various applications are related to products and services offered by a merchant.

Continuing with FIG. 2, message application(s) 208, fraud prevention application(s) 214, and publication management application(s) 220 are provided to handle transactions and interact with users. The message application(s) 208 provide an email application for use by the system for interacting with clients. Email protocols are methods used to both send and receive email messages. The Post Office Protocol (POP) protocol provides a simple and standard way for users to download email messages from a remote server over a Transmission Control Protocol (TCP)/Internet Protocol (IP) type Internet connection. Similarly, the Simple Mail Transfer Protocol (SMTP) protocol is a protocol that allows for transferring email messages over the Internet. Each message sent over the SMTP protocol can contain multiple recipients and various text data, as well as other encoded objects. These encoded objects may include images, documents, and so forth.

The communications application(s) 202 may act as a mail client to allow communications from within and among other applications. In this way, when an issue arises during operation of an application, that application is able to send information directly to the current user of that application. Further, users are provided with a way to communicate directly with the application. In one example, a mail client may be used to implement a chat session between a representative of an application and a user of the application. The representative may be an automated or robotic representative, pre-programmed to respond to a variety of communications. Modules 30 further include personalization application(s) 210 and reputation application(s) 204 which allow customization of a user experience.

In some embodiments, rebate processing application(s) 222 processes rebates based on transactions within a system, in cooperation with risk analysis application(s) 216. In a networked computing system, some applications and programs are resident at a central server, including those enabling access to databases based on user input from client machines. Typically, such applications and programs are implemented using a Common Gateway Interface (CGI) application.

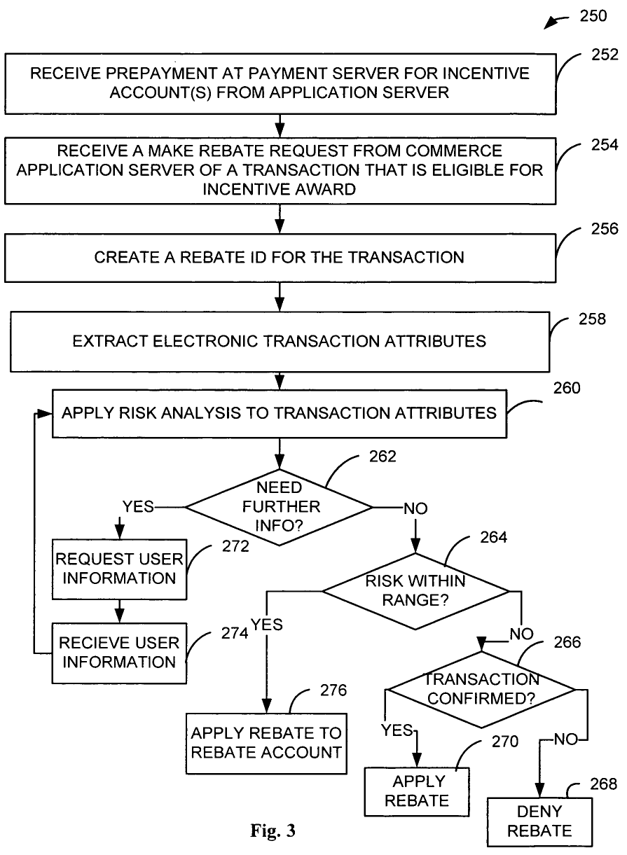

FIG. 3 illustrates a method 250 to provide rebates in a networked application which integrates a search server to implement a rebate or cashback program for transactions, such as in a marketplace or merchant system supported by a server. The rebate may involve a payout of some portion of a transaction amount immediately on completion of the transaction or may require a participant to the transaction to wait a predetermined period of time. The process according to an example embodiment analyzes the risk of providing the rebate immediately without waiting to confirm completion of the transaction. For example, in traditional systems, rebates are made when a transaction is confirmed as completed, meaning that a user has purchased a product or service and has not returned the product or cancelled the service. If a customer returns a product after a rebate has been paid out, then the retailer is required to retrieve the rebate monies from the recipient, a process referred to as “claw back.” This is difficult and has a negative connotation. Product sellers and service providers would therefore, rather, wait a sufficient period of time to allow a return time period to expire prior to paying out a rebate. It is possible to determine a risk that a specific user in a specific transaction will complete the transaction, and therefore, the system may decide the risk is acceptable and pay out the rebate immediately without waiting. In other situations, the system may not be willing to assume the risk, and therefore a wait period is applied prior to paying out the rebate.

Such methods and systems provide flexibility for the merchant and marketplace server, allowing the system administrator to change parameters of the program, such as the criteria to determine risk for a transaction or user. The criteria may change based on the number of users per month, so as to limit the total outstanding rebates at risk.

The processing allows tracking of each transaction, as well as the number of completed and uncompleted transactions. Additionally, tracking transactions and evaluating keywords used to search and identify products and services. The system may restrict specific categories of products from rebate eligibility for scalability, such as those products with low profit margins. Further, some system allow a user to differentiate results having rebate eligible items from non-eligible items, and is able to limit search results to just rebate eligible items or just rebate non-eligible items.

The tracking of transactions may include using a timestamp to record the time that the rebate amount offer (e.g., a percentage off) was made available to the user for a specific item offer and a specific time. The timestamp may be used, for example, to ensure that the rebate amount is valid or to prevent abuse. To illustrate, if a single rebate amount of 20% on a specific day was offered, it may be desirable to validate that no rebates were processed for higher or lower than 20%. Rebates other than those for 20% off would be rejected as invalid as they are likely based on manipulated URLs. In other instances, if a range of rebate amounts are offered for different items, it may be desirable to ensure that a rebate offered during that period is within the valid range of rebates offered by comparing to a data range stored (and or dynamically looked up) in a database. Alternatively or additionally, the valid rebate amount (e.g., an amount or percentage) for a specific transaction is encrypted in the URL that is submitted by the user. Two types of abuse that may be detected using the timestamp may include manipulation of the rebate URLs in an attempt to receive a higher rebate and repeated use of a valid rebate offer amount for subsequent purchases through copy/pasting of a URL with such parameters embedded in it.

The timestamp included in the URL may allow a comparison of the timestamp within the URL to a timestamp recorded by the server issuing the rebate. The comparison may then be used to determine whether the difference in the time between when the client page was loaded in a client machine with a rebate eligible item and rebate amount, and when the rebate request was submitted into the system. If the time difference between these two is greater than a time period set within the system (for example, 1 hour), then the transaction for rebate purposes is invalid. It is noted that the timestamp may include various encryption algorithms used to transmit data securely between parties as this data.

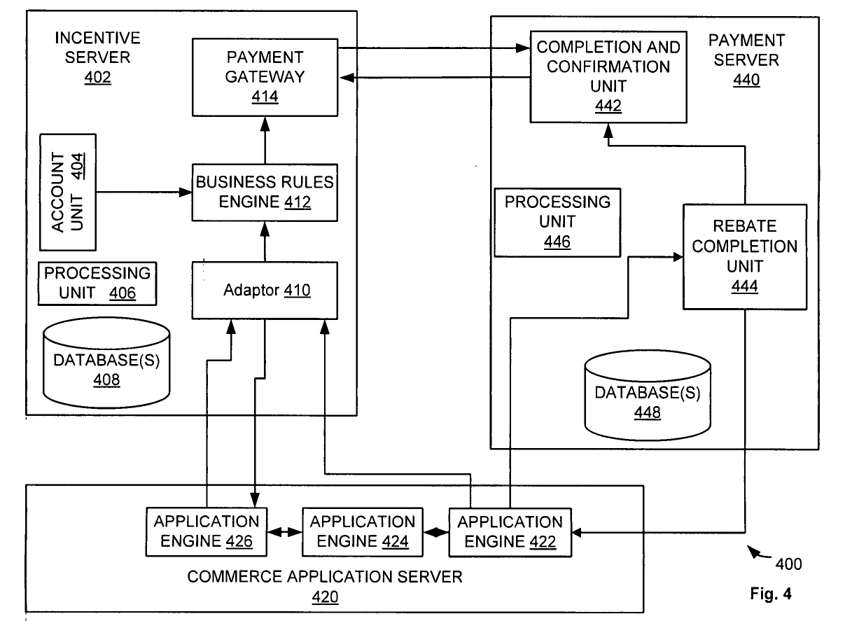

FIG. 3 is a flow chart illustrating a method for processing a rebate at a payment server, which considers the risk associated with the current transactions. The method receives a prepayment at the payment server, operation 252. The prepayment is directed to incentive account(s) and is from an application server, such as a commerce application server. The method 250 of FIG. 3 may be used in a system 400 as illustrated in FIG. 4, where a commerce application server 420 communications with a payment server 440 and an incentive server 402. The payment server 440 includes a completion and confirmation unit 442, processing unit 446, rebate completion unit 444 and databases 448. The commerce application server 420 includes application engines 422, 424 and 426. The incentive server 402 includes a payment gateway 414, account unit 404, processing unit 406, business rules engine 412 and adaptor 410.

Continuing with FIG. 3, the payment server 440 receives a request to “MAKE_REBATE” from the commerce application server 420 for a specific transaction that is eligible for an incentive award or rebate, operation 254. The MAKE_REBATE is a predefined message that instructs the recipient to initiate a rebate for the corresponding transaction and the corresponding user. The payment server 440 further creates a rebate ID for the transaction, operation 256, and extracts electronic transaction attributes from the transaction information, operation 258. The payment server 440 is a server that works in coordination with the commerce application server 420 to process payments for transactions, such as PayPal. The payment server 440 then applies a risk analysis to the transaction attributes, operation 260. At decision point 262 if further information is required, a request is sent to the user, operation 272, response is received, operation 274, and processing returns to analyze the risk, operation 260. Else, processing determines if the risk is within range at decision point 264, and if so, apply the rebate, operation 276. Else, the payment server determines at decision point 266 if the transaction is confirmed, and if so, applies the rebate 270. Else, the rebate is denied, operation 268.

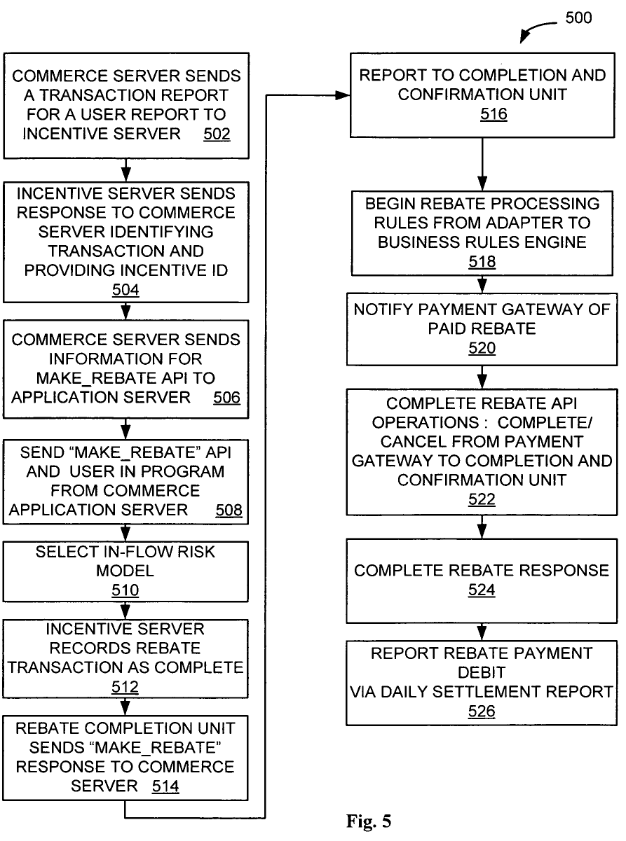

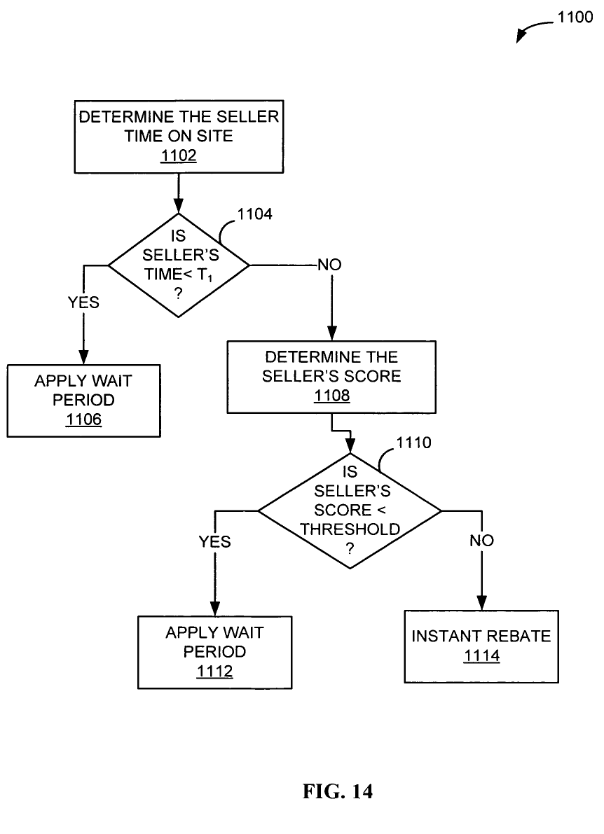

FIG. 5 illustrates a detailed flow diagram of one example of messaging to implement a method 250 of FIG. 3 within a system such as system 400 of FIG. 4. The process 500 starts when the commerce application server 420 sends a transaction report to the incentive server 402, operation 502. The incentive server 402 may be operated by a merchant or by a third party in coordination with a merchant. The incentive server 402 provides a rebate or cash back service which offers an incentive for transactions completed with the merchant. The completed transactions satisfy various criteria specified by the merchant, such as number of items purchased or length of service purchased, date(s) of purchase, type of customer, such as first time purchaser, and so forth. The incentive server 402 then sends a response to the commerce application server 420 identifying the transaction and providing an incentive ID, operation 504. The commerce application server 420 then sends information for a MAKE_REBATE Application Programming Interface (API) to the commerce application server 420, operation 506. The commerce application server 420 then sends the MAKE_REBATE API and user information to the payment server 440, operation 508. The payment server 440 then selects an in-flow risk model, operation 510. The in-flow risk model may comprise a dynamic rules engine that can receive an arbitrary number of inputs into account (e.g., seller feedback, seller location, item price, buyer time on site, seller time on site, category of item) and weight each input according to risk factors to output a binary recommendation for instant or non-instant payout. The rules may be updated dynamically based on risk models and received data and feedback loops. An example of an in-flow risk model is shown, for example, in FIG. 14. The incentive server 402 then records the rebate transaction as complete, operation 512. The completion and confirmation unit 442 sends MAKE_REBATE response to the commerce application server 420, operation 514 to confirm the transaction as complete and the rebate as valid. The payment gateway 414 sends a report to the completion and confirmation unit 442, operation 516. The business rules engine 412 begins rebate processing rules from information received from the adapter 440, operation 518. The business rules engine 412 notifies the payment gateway 414 of paid rebates, operation 520. The process 500 continues to complete the rebate API operations to send a complete or cancel message from the payment gateway 414 to the completion and confirmation unit 442, operation 522. The completion and confirmation unit 442 then sends a “COMPLETE_REBATE” response to the payment gateway 414, operation 526. The completion and confirmation unit 442 further reports rebate payment debits via daily settlement reports to the payment gateway 414, operation 526.

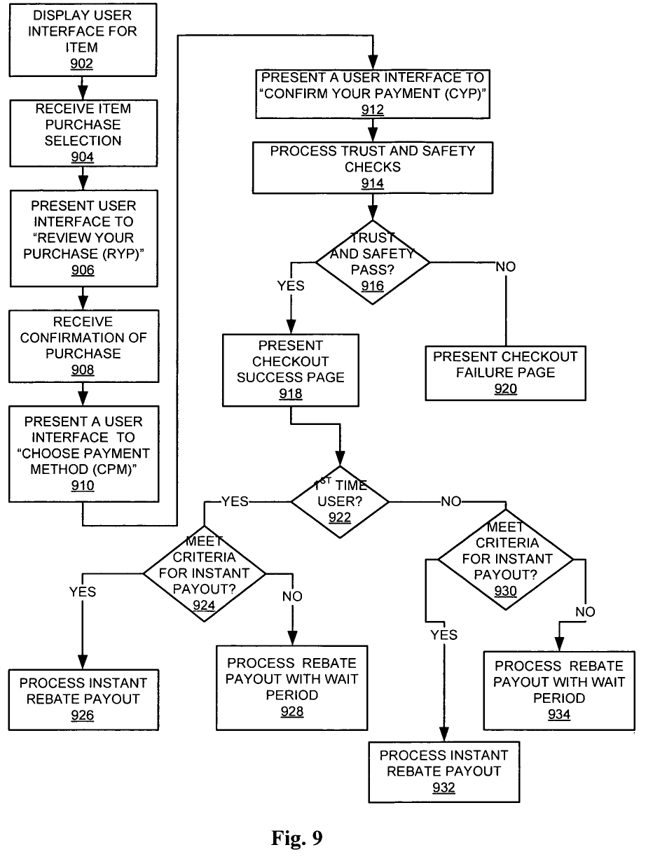

In some embodiments, rebate processing enables instant rebate payout in the server checkout flow. For example, a first time user may be identified at check out, wherein a user has at least one item eligible for a rebate. A user is a first-time user when the user is not associated with a linked search server account and a payment account and may not be allowed to receive an instant rebate. When the user has a linked search server account, the user may be considered a non-first time user. For instant payout to occur, a user is associated with a valid payment account (e.g., a Paypal account), a valid rebate account (e.g., a Microsoft Cashback account), and these two accounts are linked by the user taking some action (e.g., clicking on a link on the first transaction success page or clicking on a link in the first transaction confirmation email). Until such linking action is taken by the user, a non-instant rebate may only be offered to the user, even if this is more than one transaction. For example, a user may receive a number of rebates before clicking on the link to link the two required accounts together. While instant rebates may be possible when a user is associated with linked accounts, rebates may or may not be instant. There may be other instances or implementations where a first time user might be eligible for an instant rebate (as shown in FIG. 9, item 926).

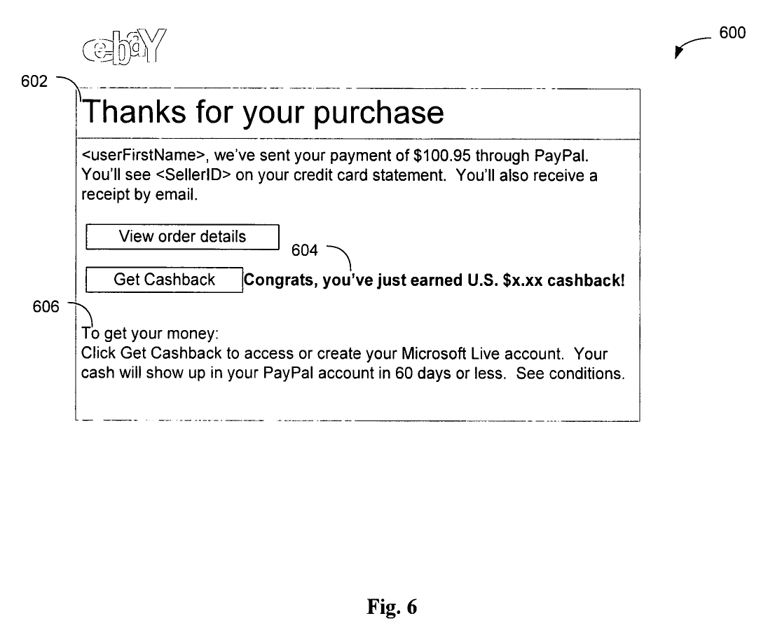

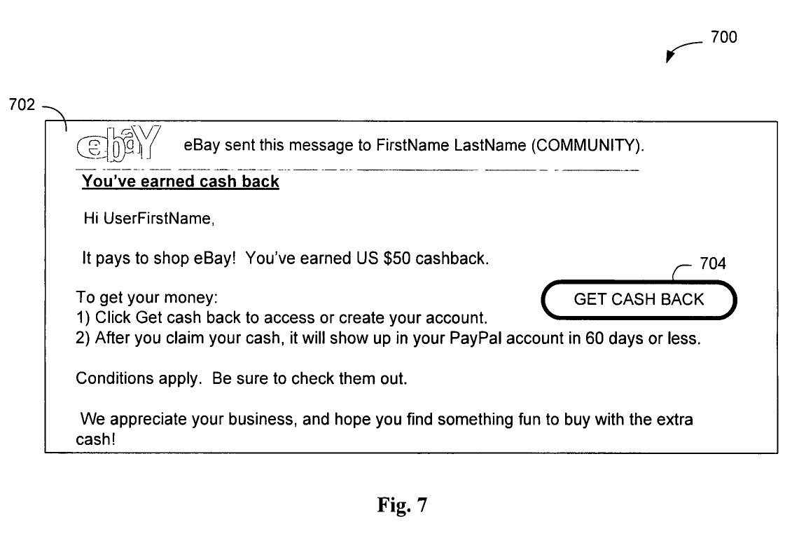

For example, FIGS. 6 and 7 includes this messaging that the user needs to create (a new) or access (an existing) cashback account to link this transaction and user to that account so that this rebate can be paid out through such account and also future transactions may be considered for instant rebate. In one embodiment, rebates may only be paid once all criteria are met including creation and linking of the accounts. At checkout the user will be presented the opportunity to receive the rebate, and a Review Your Purchase (RYP) screen will be displayed. A merchant may make a call to the search server to receive the link to the incentive server for a given user. The merchant server receives a response prior to check out processing and provides the rebate status on the CYP user interface.

FIG. 6 illustrates a user interface 600 presented to the user when a transaction is entered that is eligible for a rebate or incentive. The user interface 600 includes a message 602 thanking the user for the purchase, and a message 604 identifying the amount of cash back. Further, the user interface 600 includes instruction 606 as to how to receive the rebate.

For non-instant rebate payment, the payment server 440 pays out to the user after a wait period. When a payment is paid out to the user, the payment server 440 may, in some example embodiments, send this information back to commerce application server 420 with the specification information to tie the payment server 440 and the commerce application server 440 to the specific transaction(s) and user(s).

FIG. 7 illustrates a user interface 700 with a header 702 identifying that a cash back, also referred to as a cash back, has been earned, and a button 704 to select a cash back rebate. Other embodiments may provide this notification in other arrangements and include additional information. The user interface 700 is to indicate to the user that a user transaction has incurred a rebate or incentive. In some examples, the button 704 may enable the user to communicate with the commerce application server 420 and obtain further details regarding the incentive.

In some embodiments, a payment server may allow a guest checkout. In this situation, commerce application server users who do not already have an account on a payment server account, may create a new full payment server account using the commerce application server checkout flow. In some instances, creating the new full payment server account may make the user eligible to receive a rebate. The rebate received may or may not be instant.

Various systems and methods may be implemented to apply rebates and process rebates within various transactions and processes. Incentives generally are rebate payments and may refer to any payment made to a consumer from a commerce application server account or a merchant account to a consumer or user account for meeting a predetermined criteria of a rebate program, such as a cash back program. An instant rebate is then any rebate prepayment that is paid to the consumer without waiting for any maturation period, which in one example may be considered a zero delay maturation period, to pass subsequent to the completion of an eligible cash back purchase by the user. A rebate maturation period refers to the amount of time, such as measured in days, that is allowed to pass before the rebate payment will be processed.

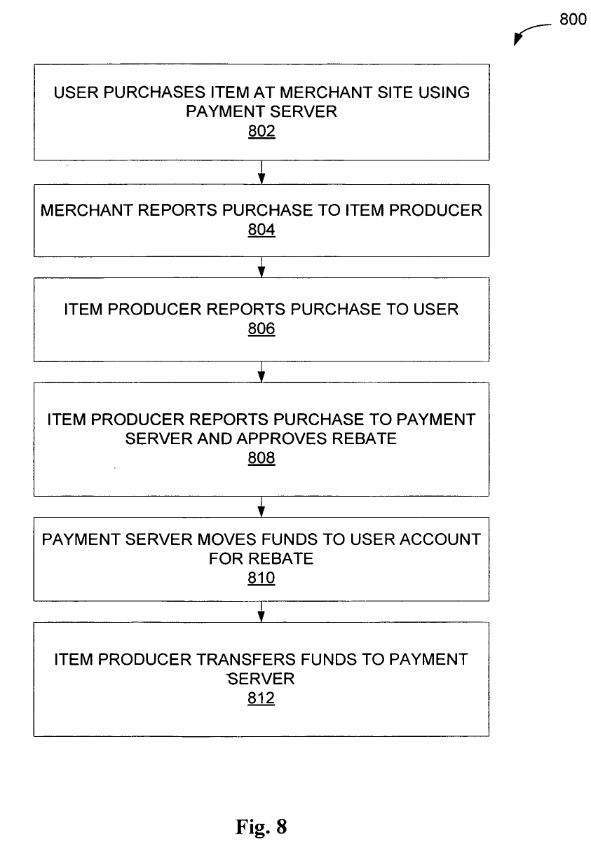

FIG. 8 illustrates a method 800 for processing a rebate in a networked system. The system includes a merchant or marketplace server, a payment server and a product supplier. The merchant provides products, or services, from the product supplier. The product supplier is effectively a third party supplier to the transaction, as a customer deals directly with the merchant.

The product supplier or the merchant may offer incentives on transactions involving products, or services. In traditional brick and mortar businesses, such an incentive may involve an immediate rebate at the point of sale, or may involve a mail in rebate. When a customer returns a product, however, the refunded amount considers the rebate. For an electronic transaction, it may be more difficult to recover the rebate amount when a product is returned. Therefore, in an example embodiment, the merchant assesses the risk that a transaction will complete before awarding the rebate. When the merchant is confident that the transaction will complete, the rebate is awarded; this is typically after waiting a predetermined period of time.

In a system as illustrated in FIG. 4, the payment server 414 assesses the risk of transaction completion and determines when to process the transaction reward. In this way, the merchant relies on the payment server to handle the risk analysis as the payment server handles a larger amount of data over a wider range of transactions. When a customer purchases a product at a merchant site, and selects a payment method, the customer is linked to the payment server. At this point, if the transaction is eligible for a reward, the payment server will analyze the risk and process the reward accordingly. In such a system, the user may be registered in a payment server which is linked to a third party server. The user may purchase from the third party server wherein the payment is processed through the payment server. The third party server acts as a merchant or marketplace providing products and services, which may offer rebates or incentives provided by the merchant or the product supplier (i.e., item producer). The method 800 starts when a user purchases an item at a merchant site using a payment server, operation 802. The merchant then reports purchase of the item to the item producer, operation 804. The item producer then reports the purchase to the user, operation 806. The item producer further reports the purchase to the payments server and approves the rebate, operation 808. The payment server then moves funds to the user account, operation 810. The item producer transfer funds to the payment server, operation 812.

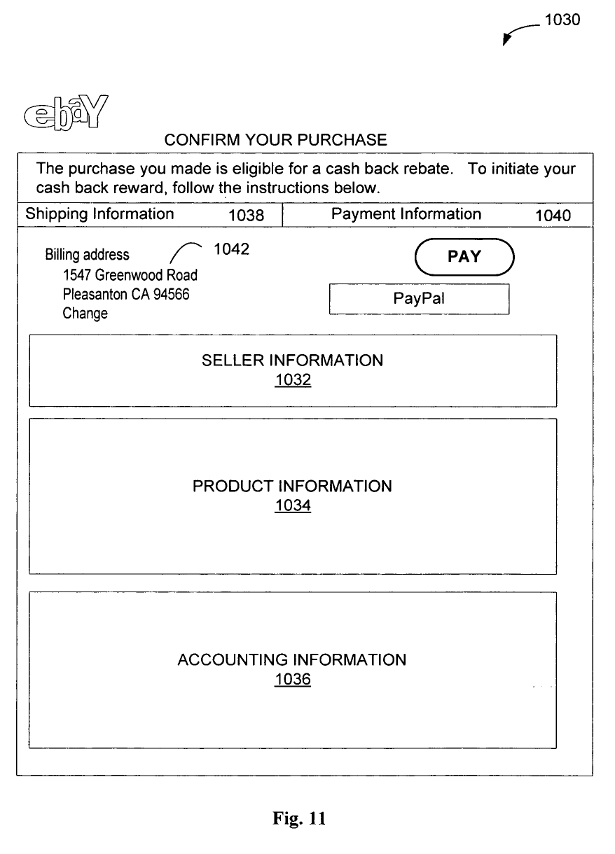

FIG. 9 illustrates an alternate method for processing rebates for transactions in a networked system according to an example embodiment. The method 900 first displays a user interface for item, operation 902. The item may be a product for sale or a service offered for sale. The system receives the item purchase selection, operation 904 and in response presents a Review Your Purchase (RYP), operation user interface 906. The system receives a confirmation of purchase, operation 908 and presents a Confirm Your Payment (CYP) user interface, operation 912. An example of a CYP user interface is illustrated in FIG. 11. The system then processes the trust and safety checks, operation 914, wherein these checks are related to the specific transaction, user, merchant and product, and may also consider the date, and payment method, as well as other considerations. At decision point 916, the system determines if the trust and safety checks pass, and if so, presents a checkout success user interface or page, operation 918, else, presents a checkout failure user interface or page, operation 920. A merchant or marketplace server may communicate with a separate trust and safety system or server to perform the trust and safety checks.

For a successful checkout, processing continues to determine if the user is a first time user at decision point 922, and if so, processing continues to decision point 924 to determine if instant payout criteria has been met. When the instant payout criteria has been met, the system processes instant rebate payout, operation 926, else the system processes rebate payout with a wait period in operation 928. The wait period may be implemented to verify that the user does not return the product or consumes the service for the agreed upon period of time. If the user is not a first time user, the system determines if the user meets the criteria for instant payout at decision point 930. When the criteria are met, the system processes the instant rebate payout, operation 932, else the system processes the rebate payout with a wait period, operation 934.

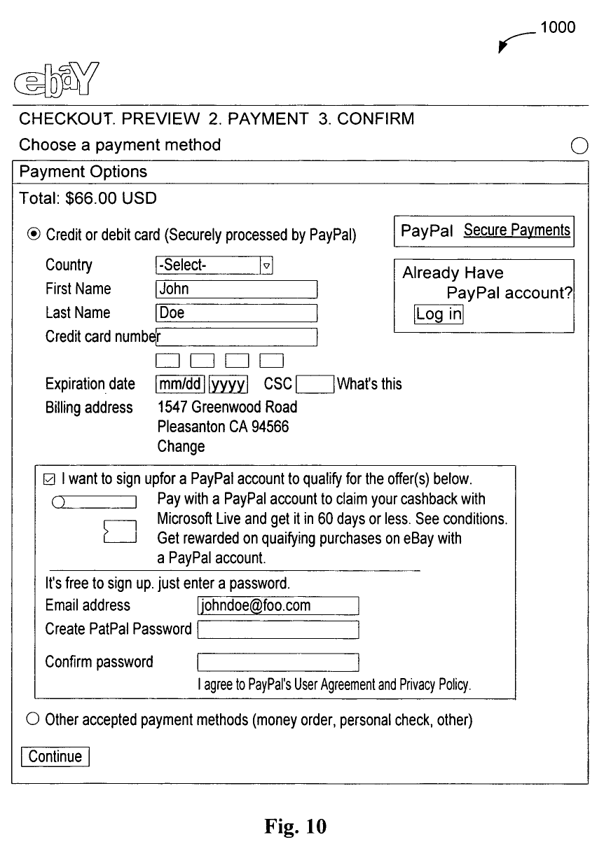

FIG. 10 illustrates a user interface presented as a payment interface 1000. FIG. 10 more specifically illustrates an instance where the user does not have a payment account at the time of purchase of a rebate eligible item. The user interface is generated to communicate that the user must sign up for the payment server account in order to be eligible for the rebate. If the user does not sign up for a payment server account, there is no account to pay the rebate amount to and thus the criteria for a rebate in our implementation are not met. The payment interface 1000 may include multiple fields with information that has been selected by a user, or pre-filled by the system. The payment interface 1000 may include selection boxes to be entered or selected by the user. In the illustrated example, the user's first name, last name, and address have been entered, but the form of payment has not been entered. This allows the user to review the information that is currently in the system, and either use that information, or amend this information. The user may also add to this information and complete the payment information. The information input into the payment interface 1000 is provided to the payment server for processing, and may be isolated from the merchant or incentive server.

The system presents a Confirm Your Purchase (CYP) interface 1030 as in FIG. 11 to the user. The CYP interface 1030 may be provided to the user when the user commits to the purchase transaction (and to the process that may include a rebate). In the embodiment shown, the transaction has not happened yet. It is noted that an Order Status screen including all this information may appear similar to the CYP interface 1030 and which may be provided after the purchase has taken place. The CYP interface 1030 may be a web page presented including shipping information 1038 and payment information 1040. The CYP interface 1030 further details the billing address 1042 and may list other user information. The payment information 1040 may list the specific method of payment used for the transaction. The CYP interface 1030 further may include seller information 1032, product information 1034 and other accounting information 1036 related to the transaction. This information allows the user to confirm the purchase (by, for example, clicking on a “PAY” button as shown) and all of the specifics associated therewith. The CYP user interface 1030 may also identify the status of a transaction as eligible for a cash back reward (not shown).

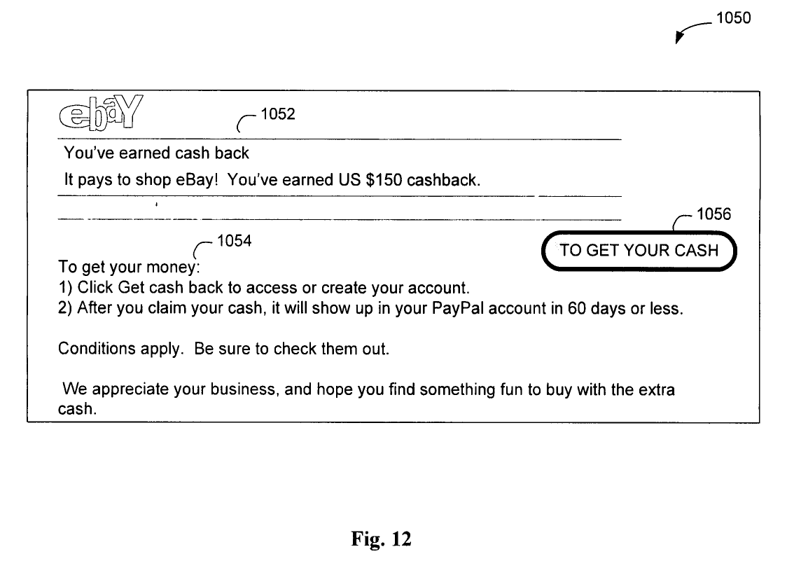

When a user is a participant to a transaction that is eligible for an incentive transaction, the system presents the user with a notification, such as by a user interface as illustrated in FIG. 12. The user interface 1050 includes a notice 1052 that alerts the user that they have earned a cash back award or rebate, and provides instructions 1054 that indicate how to obtain the award. Additionally, there is a button 1056 which provides a link, such as a hyperlink, connecting the user to a site which enables the user to link the user's accounts and enable payout of this rebate and potential instant rebates in the future. The link may be to a document or external link, or may send user information to a server to initiate the rebate.

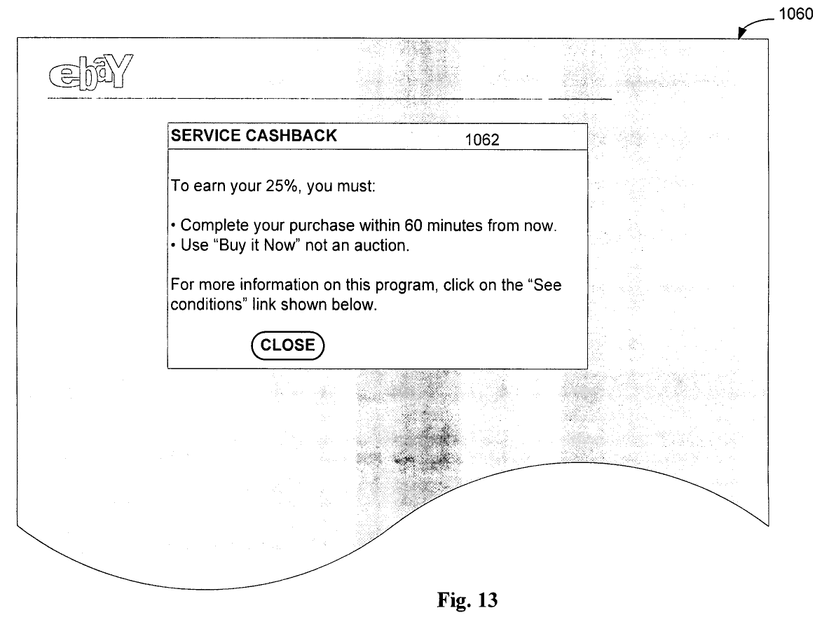

The link may be to service the reward such as through a link as illustrated in FIG. 13, wherein a user interface 1060 includes service screen 1062 with instructions for initiating processing of the cash back reward. The embodiment of FIG. 13 may be used to educate users about the rebate at the merchant site. By using an interface like that shown in FIG. 13, where the user takes an action like clicking on the close button to proceed, may increase the likelihood that the user will read the message and avoid confusion if a subsequent purchase is not eligible for a rebate. While the present example considers a cash rebate, some embodiments provide other rebates as rewards to users and customers as incentives for transactions. The specific instructions illustrated in FIG. 13 are provided as an example, and other examples may include other steps or instructions and may not necessarily involve further purchases. For example, in one embodiment a reward is provided when a user recommends a product to a friend. In another embodiment a reward is provided when a user completes a survey of a product. In still another embodiment a reward is provided when a risk analysis is performed for a current transaction resulting in a score within a predetermined target range corresponding to a consumer that more often than not completes purchases.

In some embodiments a merchant may call an incentive server to establish a rebate link for a specific user. The merchant waits for a response from the incentive server prior to initiating the reward processing. This may be done prior to completing a check out process or presenting a CYP interface. The merchant, such as a commerce application server, may receive information from the incentive server including a user ID, which may be encoded with other information. The merchant may use this information to complete the transaction. In response, the customer may then receive the rebate by accessing the incentive server or through a payment server. In some examples, a customer may create a new account, or register, with the incentive server. In order for there to be an instant payout in one embodiment, the user may be required to have existing accounts in both the merchant server as well as the search (Microsoft) server. If a user does not already have an account with the incentive server at the time this process is started, a user may be provided an interface to register for such an account in the middle of the process and link the account to an account at the merchant server and/or the incentive server.

When the merchant/marketplace user creates a new account or links an existing search server (e.g., the incentive server 402) user account via accessing this rebate server link, button, or function, this will link these two accounts which will enable the possibility of instant payouts on subsequent purchase checkout events on the merchant/marketplace. This link may be presented to the user on a web interface, in email content or by way of other communication method. In some embodiments the addresses of the servers are Universal Resource Locator (URL) addresses and are known, while in other embodiments the URLS are hidden.

The user may, in some example embodiments, be presented with a link or other call to action, such that the user may go to incentive server, and create a new account or link an existing account, such as to login, to the user account on the merchant server, in order to proceed to the next steps to claim their rebate. This may involve a step to link get cash back and may, in some example embodiments, spawn a new browser window. In some embodiments, after a risk analysis is done and it is determined to award the incentive, a notification may be emailed to the customer according to the timing determined.

In some embodiments, along with the notification will be provided additional information from the merchant referred to as a Review Your Purchase (RYP) page. The merchant determines if the user account is in good standing and if there is a record of a link established between the merchant and the user account, and that the user account status is still in good standing and valid. Some systems maintain a time period in which subsequent checkouts may, in some example embodiments, honor this initial call and buyer status, wherein this time period may be configurable.

Account validation may include many forms, including checking that the account is not only in good standing (no known negatives), but also to affirm that the account also exists and is a true valid account (e.g., not fictitious or fraudulent). Some embodiments may validate that the user account with the incentive server is a valid account (i.e., not closed or restricted) through an API call to the search server. There may be some time period between when this validation occurs between the systems and when the purchase is completed (usually seconds or minutes) but this time period may be much longer (hours or days if a user does not proceed through the purchase flow). Therefore the merchant servers and/or payment servers may set (configurable) time limit during which the assumption will be made that the account status with the incentive server is still valid (for example, 1 hour). If the time period between when the first account validation call was made and the next step in the purchase flow is taken exceeds the set limit, then another validation call may be made to re-validate the account status in one embodiment, or in another embodiment, the transaction will default to non-instant payout to enable post transaction account validity prior to payout.

In some embodiments, at the RYP page, the merchant server may have information about the transaction, for example, buyer user ID, seller user ID or IDs, and/or whether the buyer account already has a link to a search server account. The buyer in this transaction may have already made a prior purchase from the same or different seller, and then subsequently successfully completed the account linking process of a buyer account with the search server account. The merchant server may have a record that this buyer account has had a linked search account. For example, the buyer may have conducted multiple purchases allowing this linked account status to be determined and stored within the merchant server. Knowledge of whether the buyer has a linked account with the merchant server may be used to determine whether payouts may be made instantly (i.e., this is a non-first time transaction for this buyer account). What may not be known is whether the search account linked to the merchant server account is still valid, active, and/or eligible for an instant or non-instant rebate at the time of the current transaction. Therefore, the API call may be made from the merchant server to the search server when there is a clear intent to purchase or a commitment to purchase has already been made. The timing of the API call allows time for the search server time receive the API request, process the request, make a determination regarding whether the account is valid and/or active and make a payout recommendation (e.g., instant or non-instant) and to send that request back to the merchant server before the buyer has completed through the transaction flow.

Generally, the buyer may spend at least a few seconds to indicate a form of payment on the “Confirm Payment Method” page and this may allow enough time to receive a response from the search server but if the response is too slow or the buyer proceeds through the flow too quickly, then the rebate payout logic would classify the incentive server as non-instant payout since no valid search account could be validated. This may occur in cases where the buyer already has a linked account with the search server and this is already recorded in the merchant system from a prior transaction (but re-validation failed), or in the case where no prior record of linked accounts is known in the merchant system, but the buyer could have successfully linked their buyer account with the search server after a prior transaction, but the merchant system may not have this information until the subsequent (current) transaction where the validation request is being made, unless a separate linked account record reconciliation process is used.

In some instances, there may be a record in the merchant system that a buyer account has been successfully linked previously to a search server account, but since that earlier transaction, the search server account has been closed, or is no longer valid, or eligible to receive any rebates, so this re-validation step may be performed ensure that the valid linked accounts are in good standing.

On checkout, the merchant presents a Confirm Your Payment (CYP) interface and may call to a trust and safety system during or prior to a last step of a checkout. The input to the trust and safety check is a buyer user ID; the trust and safety system returns an output list of sellers or merchants that are linked to the buyer along with their probabilities. The probabilities may involve probabilities that these are connected accounts. For example, if both buyer and seller accounts share same address, credit card information, account names (not user names), etc., then the transaction may be violating terms and conditions of the program since this transaction is not actually between two different people, but someone trying to simulate a transaction to get a rebate payment. Other examples include where there is no actual transaction of goods, or simply transferring money from one pocket to another (this may be classified as fraud). Threshold criteria may be applied to each of the users on the list, and those having a probability satisfying the threshold are recommended for a non-instant transaction or application of a waiting period. In an alternate method, those having a probability below the threshold may be recommended for instant rebate payment or no waiting period. In some embodiments, rebates for a user account are held until they reach a certain amount, such as $50.00, and then the rebate is paid out. Similarly, some rebates may be paid on a scheduled time pay out, which may be configurable, such as a variable number of days or a rolling window. In some embodiments, if fraud is suspected, the transaction may be blocked. In one embodiment, rebates are offered based on a condition of the seller account, such as fixed price related, or transaction volume of the merchant.

The rules engine may weigh any number of factors regarding whether to payout instant or non-instant. These factors in the system implemented may include (and are not limited to): transaction volume of the merchant, one or more default values, one or more currency values, a seller non-performance metric, a seller feedback metric, and an amount of time the seller has been associated with the site.

The transaction volume of the merchant may be helpful with high volume sellers who have a large volume of rebate eligible purchases. The system may track the volume of total rebates per seller account over account lifetime, or rebates over any specific time period (e.g., days/weeks/months) and limit the amount of instant payouts once the account reaches such limit or limits. The system may then send back a non-instant payout response for all subsequent rebate decisions until either the time period is reset or seller account is reset to enable more instant payouts through another process (could be either manually or automated reset process).

In some instances, high volume sellers may prove to be valid merchants and thus justify different rebate criteria than other seller accounts (through proven performance as a valid and reputable seller). In one embodiment, the seller receives no notification or is unaware of the rebate processes involving the buyer and regarding the purchase of their items, but might see an increase in repeat purchases by the same buyer.

A default value approach may be used to create control sets to evaluate risk models of other seller groups. For example, all sellers with a user ID ending in the number 1 might be selected into a group for evaluation and comparison against others, and set to either instant payout or non-instant payout depending on the goal of the control group.

A currency value may be used to evaluate the currency of the transaction, as transactions in some currencies may be deemed more risky than others based on prior evidence or risk modeling, or establishing a control group

A seller non-performance (SNP) metric may be used to evaluate the history of a seller and determine whether the seller has had problems with not concluding their part of the transaction with other prior buyers in separate transactions. If the seller had a record of prior non-performance (not meeting their obligations), based on a variable threshold and variable criteria like number of chargebacks, or buyer negative feedback scoring, then the rebate might be classified as non-instant as the risk of the buyer not receiving the item would be higher and resulting in increased work to reverse an instant payout.

Similar to above, seller feedback scoring may be a measure of seller quality and reputation which can be used in risk models and thresholds set to determine instant or non-instant payouts. Each seller may be associated with a number of different dimensions of seller feedback including absolute score, percentage score (the formula is variable but mostly a percent of positive buyer feedback scoring), and also sub-scoring criteria like fast shipping time, good communication, high quality descriptions, and reasonable shipping costs.

The time on site may be a time between when a seller account was registered on the site and when the seller is involved in a rebate transaction. The time on site may be used as a measure in fraud prevention and risk management. The longer time period an account is open, the lower the risk is in most cases. For example, rebate requests for transactions with seller accounts that were opened within the last hour prior to the transaction may be deemed higher risk of fraud and thus indicate that a non-instant payout recommendation should be made to provide more time to ensure such transactions are valid, or if not, to not have to go through the reverse payment process.

When a user has a history of non-performance, the recommendation may be for a non-instant rebate, or to apply a wait period. FIG. 14 further illustrates seller considerations that may result in instant or delayed rebates. The method 1100 determines a time the seller has offered a product or service on a site, operation 1102. This time is then compared to a time T₁, decision point 1104, and when the seller's time is less than T₁ a delay period is applied, operation 1106. In this case, the product is new to the merchant or seller and there is insufficient history to predict transaction completions. If the seller has been providing the product for longer than T₁, then processing continues to determine a seller's characteristic, operation 1108, such as a seller's score. The score may be a feedback score based on participants to transactions with the seller. At decision point 1110 the seller's score is compared to a threshold value, and if the seller's score is less than the threshold value a wait period is applied, operation 1112; else the rebate is applied instantly, operation 1114. In some embodiments, the determination is made as to when to apply the rebate and a recommendation is made to the payment server. In response, the payment server applies the rebate accordingly. In some embodiments, the payment server performs the risk analysis and implements the rebate timing. The merchant or the payment server may set or vary the thresholds used to make the analysis and decisions.

In some situations there may be multiple item check out. In these situations, some items may be recommended for instant payout, while other items are recommended for delayed payout. The total rebate amount, therefore, may be paid out as delayed, using a common treatment, wherein the messaging is as a single transaction item with a non-instant rebate. Other embodiments may treat individual items separately. One scenario may include an instant-eligible rated portion of the rebate paid out instantly with the non-instant rated portion paid out non-instantly, and messaging indicating the division of the payout and timing of payouts.

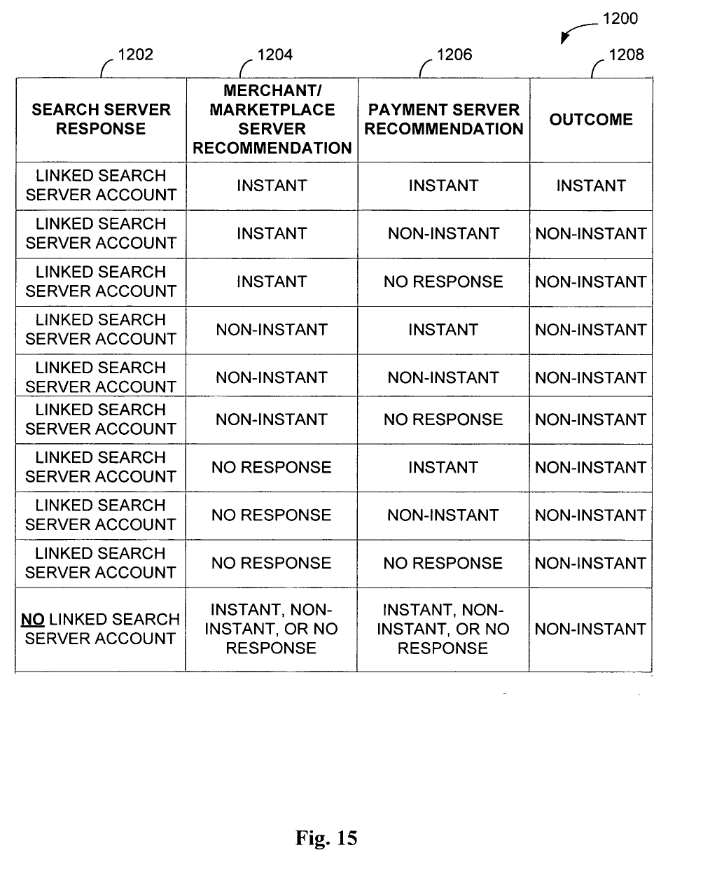

FIG. 15 is a response matrix 1200 illustrating various scenarios and the recommendations presented by the entities of the systems, including the merchant, the incentive server, and the payment server. The matrix includes the final outcome of considering the recommendations. The matrix 1200 includes columns 1202, 1204, 1206, and 1208 for search server response, merchant recommendation, payment server recommendation, and outcome, respectively. In the illustrated example, the matrix results in an instant outcome when both the merchant and the payment server recommend an instant rebate.

The merchant may communicate with the payment server, such as to make a call to the payment server to initiate a risk analysis, wherein the payment server returns a decision regarding risk. The decision indicates whether the rebate is to be paid out with or without delay. Appropriate messaging may or may not be included in check out to the customer.

There may be three factors in the risk analysis. The first may be based on a search server response as to whether account linking has already been performed. The second may be based on a marketplace/merchant server recommendation as described at least above with respect to the rules engine. The third factor may be a payment server recommendation that is similar to the second factor but performed by the Payment system (for fraud and other evaluation steps) to make a recommendation for instant or non-instant payout.

In the embodiment shown, all three factors must be met in order to have an instant payout occur. This matrix table illustrates all the different possibilities of responses (instant, non-instant, and no-response) (no response is the case of connection/server time out or hardware failure or other communication issues). The first line is the only case when instant will occur, and the last line indicates that without a linked account, there cannot be an instant payout regardless of what the other two systems would or do recommend.

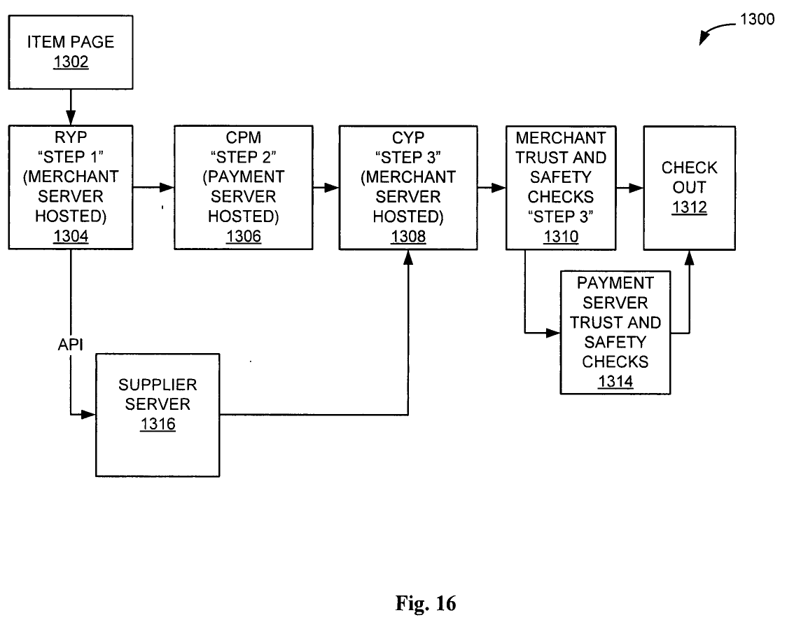

FIG. 16 is a flow diagram illustrating a check out flow in a system supporting rebates, according to an example embodiment. The method 1300 includes operations to present an item page, operation 1302, such as an eBay item page. The method then presents a RYP user interface page, operation 1304, which may be hosted by the merchant server. At operation 1306, a Choose Your Payment (CPM) user interface is presented to a user, which receives payment information from the user. The merchant server also makes an API call to the payment server, which initiates generation of a CYP user interface, operation 1308. The trust and safety checks are performed at operations 1310 and 1314 by the merchant and the payment server. Finally, when these processes are successful a checkout process is completed at operation 1312.

Various security scenarios may be implemented in coordination with the risk analysis and rebate applications. An impression time stamp may be used to apply a qualification to a user for dated rebates. Servers may capture the time when a user searched for items and products, times when items were rendered and times when products were purchased. The security may include validating that the elapsed time between the time stamp of the retrieved information and the current system time is within an allowable range.

Some embodiments apply a digital signature validation as a security check. The digital signature uses an asymmetric key validation to verify the integrity and accuracy of the incoming information. Various trust and security checks may be implemented to verify the rebate processing for a user, product or time period of application of a rebate.

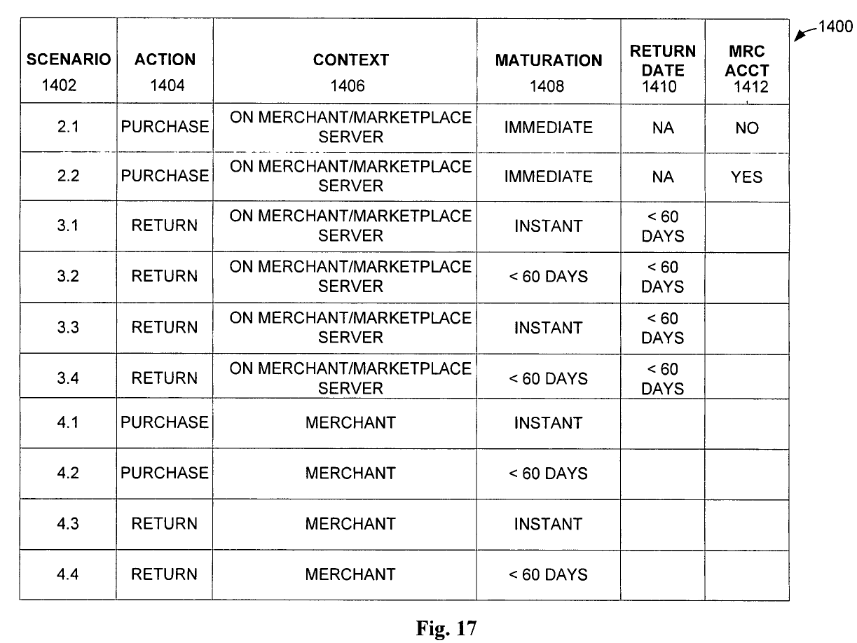

Further, various scenarios may apply to rebate processing. FIG. 17 is a table of summary of various rebate scenarios.

In some embodiments, a user accesses a search server to search for an item, wherein a payment server enables delivery of immediate rebate payments for purchases on a merchant site. The search server enables the users to configure automatic cash back payouts using the payment server at an incentive server. The search server may provide the payment server with synchronous information that confirms whether the user have completed the transactions and a status of their accounts. For example, the system provides an indication as to the status of the user's merchant account, payment account, and incentive account or rebate account. This information may include, for example, payment server user ID, order ID, and rebate amount, merchant Data, and so forth.

In a first example, a user may make a purchase of an item on a merchant server, wherein the transaction qualifies for a cash back rebate. The payment server analyzes the risk of the transaction and determines that the rebate may be paid out instantly. In this scenario, the user has a cash back account set up with the payment server. The user, Sarah, goes to the search server or service provider and searches for an item, such as product B. She finds an advertisement for B from a merchant site presented by a merchant server offering a cash back rebate. The cash back rebate has a visual representation. Sarah is a user previous merchant customer and has received cash back rebates before. She clicks the ad where she sees several cash back visual representation of a valid rebate session indicator to the merchant/marketplace user for Buy-It-Now auctions for B she may be interested in buying. Sarah goes through the merchant server purchase flow and selects to use her payment server account to purchase B. When she finalizes the purchase through payment server, she sees the merchant server and payment server receipt page that tells her the $15 rebate may be available instantly. Sarah receives an email from the payment server stating that the money has been received from the search server as part of the rebate program. Additionally, Sarah receives an email from the cash back indicating that the purchase was received and the rebate was deposited to her payment server account. Sarah may also receive a notification from the merchant that the rebate has been deposited into the payment server account.

In some embodiments a merchant server may apply a maturation period, such as a 60 day maturation period, prior to paying a cash back rebate. In a first scenario, a user makes a purchase on a merchant server wherein the transaction qualifies for a cash back rebate. At the time of purchase, the maturation date may be determined by payment server to be the default 60 days.

In a second example, a user does not have a cash back account. The user, Jane, goes to the search server, or service provider, and searches for a copy of a software product, B. Jane sees an ad for B from the merchant, wherein the merchant offers a cash back rebate. Jane has purchased from the merchant before and has a merchant user account. Jane likes the idea of getting a cash back rebate on her purchase of B from the merchant. Jane clicks on the ad, which takes her to merchant server. Jane goes through the purchase flow and chooses to use her payment server account to purchase product B on her merchant user account. When Jane makes the purchase of B, the receipt page indicates that the cash back rebate will be available after a waiting period, and after she registers for a cash back account. Jane may then click on a secure link on the purchase confirmation screen which goes directly to register for a cash back account. Once Jane fills out all the required information, her rebate may be added as pending in her cash back account. After 60 days, Jane receives an email from the search server saying that her rebate has been deposited in her payment server account. Additionally, Jane receives an email from the payment server stating that she has received money from the search server as part of the search server's rebate program. Jane may also receive a notification from the merchant that the rebate has been deposited into the payment server account

In a third example a user returns a purchase within 60 days of the purchase date, wherein a rebate had been issued instantly. The user made the purchase on a merchant server, and qualified for an instant rebate. The user later returns the item subsequent to receiving the rebate. The user, Sarah, had previously purchased the product, a watch, on merchant/marketplace server and returned it to the seller because it did not fit. After the seller received the watch, the seller initiated the return process through payment server. The seller or the payment server may notify Sarah that the purchase price has been or will be returned to her account. She may be also notified that the cash back rebate will be or has been taken out of her account. These would show up as two separate transactions on her payment server account. One transaction may be a credit for the original purchase. The other transaction may be a debit for the rebate. In addition, her rebate center account may be updated to reflect that the purchase has been returned and the cash back rebate amount has been returned.

In a fourth example, a user, Sarah, makes a purchase on merchant server, wherein the transaction qualifies for a cash back rebate. The user receives the rebate prior to expiration of a standard, default 60-day window; the user then returns the purchased item. In another previous transaction, the same user, Sarah, had previously purchased a watch on the same merchant server and received an instant cash back rebate. Sarah paid for the watch through the payment server. Sarah used the watch for a few months, but returned the watch when it failed. Sarah attempted to rectify the situation with the seller before returning the watch, but to no avail. Sarah then decided to return the watch. After returning the watch to the seller, the seller initiated a process to return payment to Sarah through the payment server. Sarah may be notified that the purchase price has been returned to her account. She may be also notified that the cash back rebate has been taken out of her account. These transactions would be indicated as two separate transactions on the payment server account, wherein one transaction is a credit for the original purchase, and the other transaction is a debit for the rebate. In addition, Sarah has a rebate center account that will be updated to reflect that the purchase price amount and the cash back rebate amount has been returned.

In a fifth example, a user, Jim, makes a purchase on a 3rd party merchant server, which has agreed to participate in the off merchant transaction with a payment server account, and wherein the transaction qualifies for a cash back rebate. The payment server analyzes the transaction and determines that the transaction qualifies for an instant rebate. Jim may be an avid cash back participant and a payment server user. In his cash back account, he opted into sharing his cash back information with the payment server so as to receive the cash back rebates more quickly. Jim searches using the search server, or service provider for cash back and searches, such as to search for video games. He accesses merchants through the search server, as well as accessing the payment server through the search server. When purchasing products through a merchant, Jim is able to link directly from the search server to the payment server.

In a sixth example, a user returns an item to a 3rd party merchant, wherein the item had an associated rebate which was paid out instantly at purchase. The user, Sarah, had previously purchased a watch at a merchant site and paid for the watch using a payment server. Sarah received an instant cash back rebate through the payment server. After receiving the watch, Sarah decided to return the watch as it was larger than she originally thought. After the merchant received the returned watch, the merchant processed a refund for the transaction with the payment server and reversed the original purchase transaction. Additionally, the merchant reported the return to search server or service provider using a return reporting mechanism supported by the search server. Sarah may be notified by the search server that the purchase was returned and therefore the rebate has been retrieved from her payment account or her rebate account as well. Such accounting information may be stated in a policy statement of the search server, the payment server, the merchant, the incentive server or other participant to the transaction or the rebate process. Sarah may further be notified by the payment server that the cash back rebate has been taken out of her account. Sarah would see two transactions in her payment server account. One transaction may be a credit for the original purchase. The other transaction may be a debit for the rebate.

In a seventh example, Sarah may have previously purchased an item on a merchant site and paid for the item using a payment server, and received a cash back rebate after 60 days. Sarah receives the item and keeps it for a few months and then returns it after emailing customer service at the merchant. The merchant receives the watch, processes a refund transaction with the payment server and reverses the original purchase transaction. Additionally, the merchant reports the return to the search server using an API provided the search server to report returns. Sarah may be notified that the purchase price has been returned to her payment server account. She may also be notified that the cash back rebate has been taken out of her payment server account or her rebate account. These amounts may appear as two separate transactions or may appear as a single entry in the payment server account. One transaction may be a credit for the original purchase. While another transaction may be a debit for the rebate. In addition, her rebate account may be updated to reflect that the purchase has been returned and the cash back rebate amount has been returned to the merchant or product manufacturer.

FIG. 17 is a table summary of various rebate scenarios having columns 1402, 1404, 1406, 1408, 1410 and 1412, corresponding to scenario, action, context, maturation, return date, and MRC account, respectively.

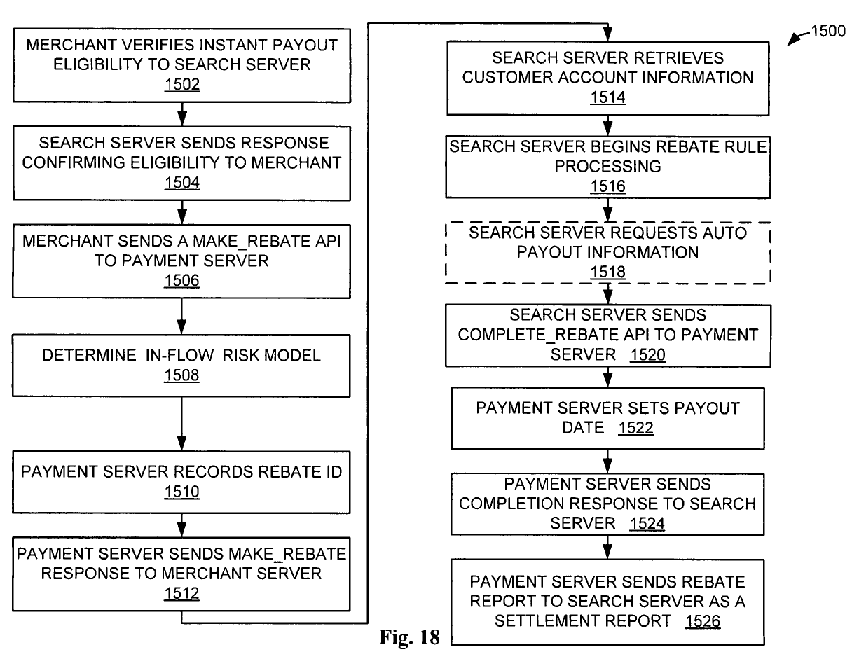

FIG. 18 illustrates a flow chart for processing rebates according to an example embodiment, wherein a process 1500 initiates when a merchant verifies an instant payout eligibility of a transaction to a search server, operation 1502. The search server sends a response confirming eligibility of the transaction to the merchant server, operation 1504. The merchant server sends a MAKE_REBATE API to the search server, operation 1506, to enable the user to initiate the rebate process. The API provides the user with entry and confirmation screens such as the RYP and CYP screens described hereinabove. The process 1500 further includes activities to determine an in-flow risk model(s), operation 1508. The risk model is used to evaluate the probability of transaction completion for a transaction that is eligible for a rebate. When the transaction has a high risk of non-completion, a recommendation is made to apply a wait period to distribution of the rebate award or cash back. When the risk is low that for non-completion of the transaction, then the recommendation is made to apply an instant rebate award. The risk model may be any of a variety of models and may consider a variety of parameters of the transaction. The risk model may adapt dynamically over time as the parameters are analyzed and evaluated for effectiveness in achieving the desired goals.

The process 1500 continues as the payment server records a rebate ID, operation 1510 and sends a MAKE_REBATE response to the merchant server, operation 1512. The search server is tasked with retrieving customer account information, operation 1514, which may be done at any time during the transaction. The search server may be the customer's service provider, and therefore has access to sufficient user information, including billing and address information, and may have additional account information, such as links to payment server accounts or merchant accounts. The search server may also begin applying rebate rule processing, operation 1516; this is initiated after a MAKE_REBATE response is received from the payment server. The search server may optionally request auto-payout information, in operation 1518 that includes information such as currency type, amount, and other transaction information. The search server sends a COMPLETE_REBATE API to the payment server, operation 1520, to indicate enable the user to complete rebate processing. The payment server then sets the payout date, operation 1522, which is determined by the risk analysis as either instant or with a wait period. The payment server then sends a completion response to the search server, operation 1524; and the payment server sends a rebate report to the search server as a settlement report, operation 1526.

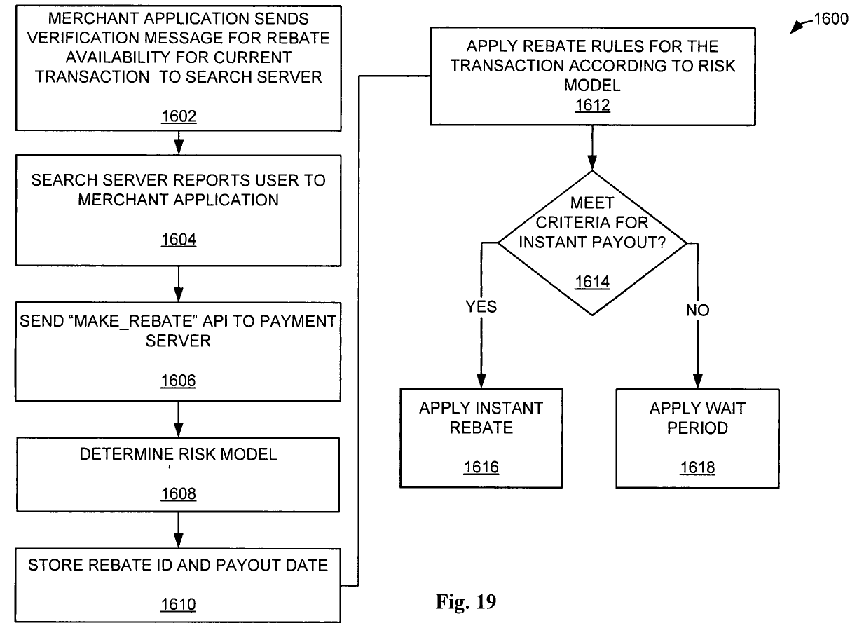

FIG. 19 is a flow chart illustrating a process for handling transactions eligible for rebates, according to an example embodiment. The process 1600 begins when a merchant application sends a verification message for to check rebate availability for a current transaction to a search server, operation 1602. In response the search server provides information on the user to the merchant application, operation 1604, such as a merchant application server, or a commerce application server, or a merchant server. The merchant server then sends a MAKE_REBATE API to the payment server, operation 1606, to enable the user to facilitate the rebate and collect the cash back reward for the transaction. The process 1600 may also include determining a risk model, operation 1608, or may use a predetermined or established risk model of analysis. The risk analysis may be performed at the payment server, which stores a rebate identifier or ID and a payout date, 1610; the payout date may be designated as a recommendation which is an output of the risk model analysis. The search server applies rebate rules for the transaction according to the risk model, operation 1612. The process 1600 continues to decision point 1614 to determine if the transaction meets the criteria for instant payout. If the criterion or criteria are met, then the rebate is applied without a delay, operation 1616, else a wait period is applied before distributing the rebate 1618.

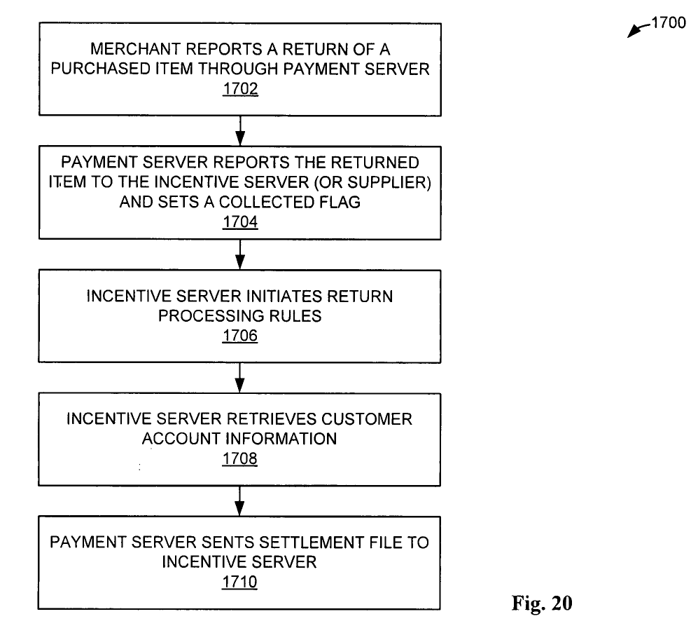

FIG. 20 is a flow chart illustrating a process for handling transactions eligible for rebates, according to an example embodiment. The process 1700 initiates when a merchant reports a return of a purchased item through a payment server, operation 1702. The payment server then reports the returned item to the incentive server, or supplier, and sets a collected rebate flag, operation 1704. The incentive server initiates return processing rules, operation 1706, and retrieves customer account information, operation 1708. The payment server then sends a settlement file to the incentive server, operation 1710.

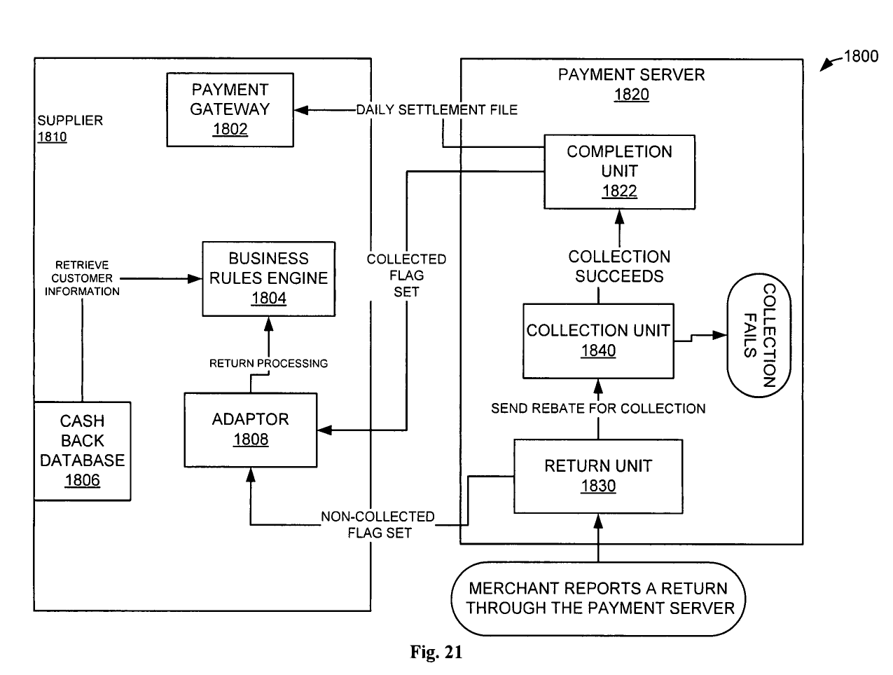

FIG. 21 illustrates a system 1800 for applying rebates to transactions according to example embodiments. The system 1800 includes a supplier 1810, and a payment server 1820. The supplier 1810 includes a payment gateway 1802, a business rules engine 1804, an adaptor 1808 and a cash back database 1806. The payment server 1820 includes a completion unit 1822, a collection unit 1840 and a return unit 1830. A merchant may report a return of an item to the return unit 1830 wherein the purchase was made with payment through the payment server 1820. The return unit 1830 sends the rebate information to the collection unit 1840 for collection of the rebate. The collection unit 1840 processes the collection. When the collection fails and the collection unit 1840 is unable to retrieve or claw back the rebate monies, the collection is marked as a failure, else the collection unit 1840 passes a collection successful message to the completion unit 1822. The completion unit 1822 then sets a collected flag and provides this information to the adaptor 1808, which sends a message to the business rules engine 1804 to initiate rules processing. Additionally, the cash back database provides the customer information associated with the transaction to the business rules engine to process the rebate for this transaction. Finally, the completion unit 1822 provides a daily settlement file to a payment gateway 1802.

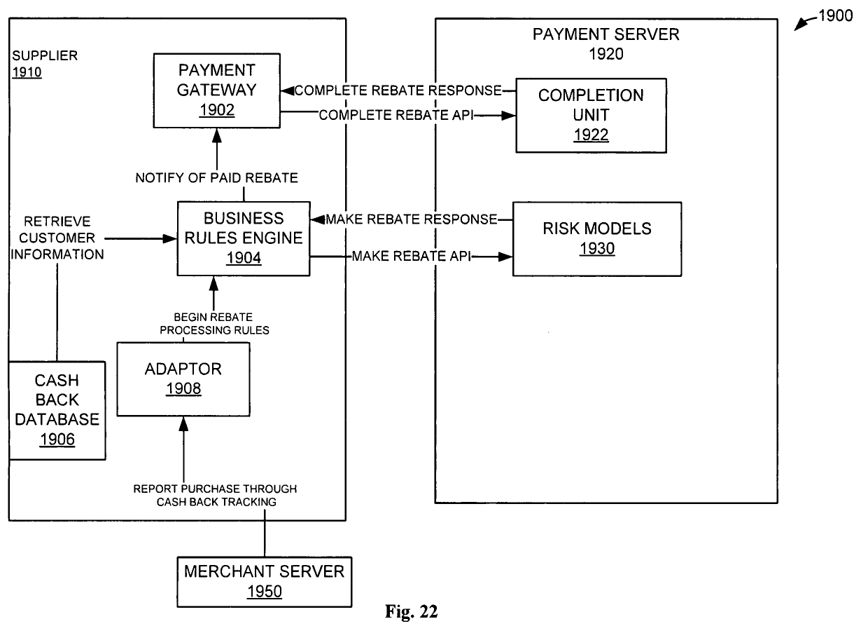

Another example is illustrated in FIG. 22, which illustrates a system 1900 having a supplier 1902, a payment server 1920, and a merchant server 1950. The merchant server 1950 reports a purchase through cash back tracking. The report is made to an adaptor 1908 of the supplier 1902. The adaptor 1908 sends a message to the business rules engine 1904 to initiate processing the rules for the purchase transaction. Customer information retrieved from the cash back database 1906 is provided to the business rules engine 1904 for such processing. The business rules engine 1904 send a MAKE_REBATE API to risk models 1930, which provides a MAKE_REBATE response. The business rules engine 1904 then sends a notification of a paid rebate to the payment gateway 1902, which then sends a complete rebate API to the completion unit 1922. In response, the completion unit 1922 sends a complete rebate response to the payment gateway 1902.

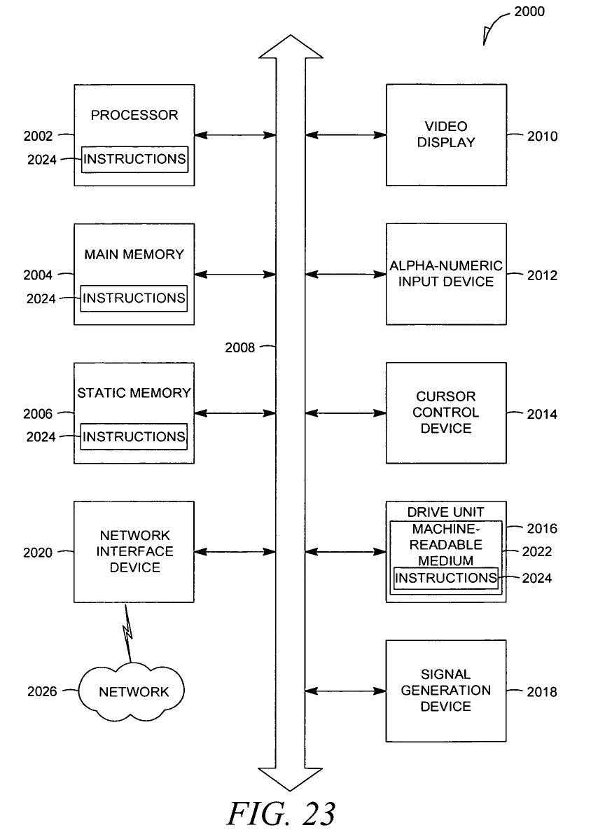

Various techniques for processing transactions and applying a risk analysis to rebate processing and using the information may be implemented in a computing device, a networked server, or may be provided as machine-readable medium. FIG. 23 is a block diagram of a computing device 2000, according to an example embodiment, for implementing a rebate method according to an example embodiment.

A specific machine may be implemented in the form of computer system 2000, within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU) a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device RR18 (e.g., a speaker) and a network interface device 2020.

The disk drive unit 2016 includes a machine-readable medium 2022 on which is stored one or more sets of instructions (e.g., software 2024) embodying any one or more of the methodologies or functions described herein. The software 2024 may also reside, completely or at least partially, within the main memory 2004 and/or within the processor 2002 during execution thereof by the computer system 2000, the main memory 2004 and the processor 2002 also constituting machine-readable media.

The software 2024 may further be transmitted or received over a network 2026 via the network interface device RR20.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain embodiments are described herein as including logic or a number of components, modules, or mechanisms. A component may be any tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component may be implemented mechanically or electronically. For example, a component may comprise dedicated circuitry or logic permanently configured (e.g., as a special-purpose processor) to perform certain operations. A component may also comprise programmable logic or circuitry (e.g., as encompassed within a general-purpose processor or other programmable processor) temporarily configured by software to perform certain operations. It may be appreciated that the decision to implement a component mechanically, in dedicated and permanently configured circuitry, or in temporarily configured circuitry (e.g., configured by software) may be driven by cost and time considerations.

Accordingly, the term “component” may be understood to encompass a tangible entity, be that an entity physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiples of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, one component may perform an operation and store the output of that operation in a memory device to which it is communicatively coupled. A further component may, at a later time, access the memory device to retrieve and process the stored output. Components may also initiate communications with input or output devices, and can operate on a resource (e.g., a collection of information).

Example embodiments may be implemented in digital electronic circuitry, or in computer hardware, firmware, software, or in combinations of these. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., as a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers having a client-server relationship to each other. In embodiments deploying a programmable computing system, it may be appreciated that both hardware and software architectures require consideration. Specifically, it may be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

While the machine-readable medium is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium capable of storing, encoding or carrying instructions for execution by the machine and that cause the machine to perform any one or more of the methodologies presented herein or capable of storing, encoding or carrying data structures utilized by or associated with such instructions. The term “machine-readable medium” shall accordingly be taken to include, but not be limited to, tangible media, such as solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions used within computer system 2000 may further be transmitted or received over a communications network 2026 using a transmission medium. The instructions, and other information, may be transmitted using the network interface device 2020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible medium to facilitate communication of such software.

In some embodiments, the described methods may be implemented using one of a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules or processes that govern the software as a whole. A third, storage tier, may be a persistent storage medium, or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology or a variety of technologies. The example three-tier architecture, and the technologies through which it is implemented, may be realized on one or more computer systems operating, for example, as a standalone system, or organized in a server-client, peer-to-peer, distributed, or some other suitable configuration. Further, these three tiers may be distributed between more than one computer systems as various components.

Example embodiments may include the above described tiers, and processes or operations about constituting these tiers may be implemented as components. Common to many of these components is the ability to generate, use, and manipulate data. The components, and the functionality associated with each, may form part of standalone, client, server, or peer computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server, client, and/or peer software application. Further, these APIs may be able to communicate through various distributed programming protocols as distributed computing components.

Some example embodiments may include remote procedure calls being used to implement one or more of the above described components across a distributed programming environment as distributed computing components. For example, an interface component (e.g., an interface tier) may form part of a first computer system remotely located from a second computer system containing a logic component (e.g., a logic tier). These first and second computer systems may be configured in a standalone, server-client, peer-to-peer, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

Example embodiments may use the OSI model or TCP/IP protocol stack model for defining the protocols used by a network to transmit data. In applying these models, a system of data transmission between a server and client, or between peer computer systems, may, for example, include five layers comprising: an application layer, a transport layer, a network layer, a data link layer, and a physical layer. In the case of software for instantiating or configuring components having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally Asynchronous Transfer Mode (ATM), Synchronous Network Architecture (SNA), Serial Data Interface (SDI), or some other suitable protocol. These networks may be organized within a variety of topologies (e.g., a star topology), or structures.

Although an embodiment has been described with reference to specific example embodiments, it may be evident that various modifications and changes may be made to these embodiments without departing from the broader spirit and scope of the present discussion. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it may be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, may be apparent to those of ordinary skill in the art upon reviewing the above description.

What is claimed is:

1. A computer-implemented method for a data processing system, comprising using at least one processor to:
receive a request for a transaction, wherein the transaction is eligible for a cash back reward;
analyze the transaction to identify a probability of transaction completion;
compare the probability of transaction completion to a threshold value;
recommend an instant cash back reward when the probability of transaction completion exceeds the threshold value; and
recommend a wait period for the cash back reward when the probability of transaction completion fails to exceed the threshold value.

2. The method of claim 1, wherein the transaction is for purchase of an item.

3. The method of claim 2, wherein the method is performed at a payment server.

4. The method of claim 3, wherein the item is offered for sale by a merchant server.

5. The method of claim 4, wherein to analyze the transaction is to determine at least one parameter of the transaction, and to compare the at least one parameter to target values.

6. The method of claim 5, wherein the at least one parameter includes a time of the transaction.

7. The method of claim 5, wherein the at least one parameter includes a user identifier.

8. The method of claim 5, wherein the at least one parameter includes a cost of the item.

9. The method claim 5, wherein the at least one parameter includes a merchant rebate identifier.

10. The method of claim 1, wherein the method is further to receive a MAKE_REBATE Application Programming Interface (API).

11. A computer system, comprising:
a processing unit to process payments for transactions with a networked system;
a rebate completion unit to receive requests to process rebates for at least of transaction;
a confirmation unit to confirm payment of a rebate and to analyze a probability of the at least one transaction completing and recommending a reward timing based on the probability; and
a database for storing information for rebate information including the reward timing.

12. The computing system, as in claim 11, further comprising:
a return unit to receive a report of a returned item from a merchant server; and
a collection unit to receive a rebate for collection from the return unit, and processing collection of the rebate; and.
wherein the completion unit is to set a rebate collected flag when collection of the rebate succeeds.

13. The computer system of claim 11, wherein the computing system is a payment server.

14. The computer system of claim 13, wherein the database stores user account information.

15. A machine-readable medium comprising instructions, which, when implemented by one or more machines, cause the one or more machines to perform the following operations:
receive a request for a transaction, wherein the transaction is eligible for a cash back reward;
analyze the transaction to identify a probability of transaction completion;
compare the probability of transaction completion to a threshold value;
recommend an instant cash back reward when the probability of transaction completion exceeds the threshold value; and
recommend a wait period for the cash back reward when the probability of transaction completion fails to exceed the threshold value.

16. The machine-readable medium of claim 15, wherein the transaction is for purchase of an item.

17. The machine-readable medium of claim 16, wherein the operations are performed at a payment server.

18. The machine-readable medium of claim 17, wherein the item is offered for sale by a merchant server.

19. The machine-readable medium of claim 18, wherein to analyze the transaction is to determine at least one parameter of the transaction, and to compare the at least one parameter to target values.

20. The machine-readable medium of claim 19, wherein the at least one parameter includes a time of the transaction.
